(19) United States
(12) Patent Application Publication
(10) Pub. No.: US 2022/0049500 A1
(43) Pub. Date: Feb. 17, 2022

(54) Solar-Reflective Roofing Granules with Hollow Glass Spheres

(71) Applicant: 3M INNOVATIVE PROPERTIES COMPANY, St. Paul, MN (US)

(72) Inventor: Kristin M. Amsden, St. Paul, MN (US)

(21) Appl. No.: 17/274,873

(22) PCT Filed: Sep. 23, 2019
(86) PCT No.: PCT/IB19/58050

§ 371 Date: Mar. 10, 2021

Related U.S. Application Data
(60) Provisional application No. 62/738,276, filed on Sep. 28, 2018.

(51) Int. Cl. E04D 7/00; E04D 1/28; C08K 7/28

(52) U.S. Cl. CPC E04D 7/005; E04D 2001/005; C08K 7/28; E04D 1/28

(57) ABSTRACT

The present disclosure relates to roofing granule having a base granule with at least one layer on the base granule that includes hollow glass spheres embedded in a ceramic matrix and a roofing article having a substrate and a plurality of any embodiment of roofing granules described above. The disclosure additionally relates to a roofing granule precursor mixture containing base granules, an aluminum silicate, an alkali metal silicate, and hollow glass spheres. The disclosure also relates to a method of making roofing granules including providing base granules; applying a coating containing hollow glass spheres, an aluminum silicate, an alkali metal silicate to the base granules; and heating the coated granules to a temperature between about 550° F. and about 1000° F.

### FIELD

The present disclosure generally relates to roofing granules. More particularly, the present disclosure relates to solar reflective roofing granules.

### BACKGROUND

For energy conservation purposes, it has become more desirable to reflect solar energy off roofs and other exterior surfaces. Absorbed solar energy increases energy costs in buildings. In addition, in densely populated areas, such as metropolitan areas, the absorption of solar energy increases ambient air temperatures. A primary absorber of solar energy is building roofs. It is not uncommon for ambient air temperature in metropolitan areas to be at least 10° F. warmer than in surrounding rural areas. This phenomenon is commonly referred to as the urban heat island effect. Reflecting solar energy rather than absorbing it can reduce cooling costs and thereby energy costs in buildings. In addition, reducing solar energy absorption can enhance the quality of life in densely populated areas by helping to decrease ambient air temperatures.

Solar energy reflection can be achieved by using metallic or metal-coated roofing materials. However, because the heat emittance of metallic or metal-coating roofing materials is low, such materials do not produce significant gains in energy conservation and reduced costs since such materials restrict radiant heat flow.

Reflection of solar energy can also be accomplished by using white or light-colored roofs. However, white or light-colored sloped roofs are not preferred in the marketplace due to aesthetic reasons. Instead, darker roofs are preferred. However, darker roofs by their very nature through colored or non-white roofing materials absorb a higher degree of solar energy and reflect less.

Non-flat or sloped roofs commonly use shingles coated with colored granules adhered to the outer surface of the shingles. Such shingles are typically made of an asphalt base with the granules embedded in the asphalt. The roofing granules are used both for aesthetic reasons and to protect the underlying base of the shingle. The very nature of such granules creates significant surface roughness on the shingle. Solar radiation thereby encounters decreased reflectivity since the radiation is scattered in a multi-scattering manner that leads to increased absorption when compared to the same coating placed on a smooth surface.

### BRIEF SUMMARY

Features and advantages of this disclosure will be understood upon consideration of the detailed description, as well as the appended and claims. These and other features and advantages of the invention may be described below in connection with various embodiments of the present invention. This summary is not intended to describe each and all disclosed embodiments or every implementation of the present invention.

A feature and advantage of the present disclosure is the enablement of roofing solutions with colors darker than, but having at least the same solar reflectivity as, roofing solutions that use TiO2 or other light-colored solar reflective materials.

The subject matter of this disclosure, in its various combinations, either in apparatus or method form, may include the following list of embodiments:

At least one embodiment of the present disclosure provides a roofing granule having a base granule with at least one layer on the base granule that includes hollow glass spheres embedded in a ceramic matrix. In at least one embodiment the hollow glass spheres are in an outermost layer on the base granule. In at least one embodiment the hollow glass spheres are in one or more layers beneath an outer layer on the base granule. In at least one embodiment the outer layer does not comprise hollow glass spheres. In at least one embodiment the hollow glass spheres have a diameter of about 5 to about 50 micrometers. In at least one embodiment the hollow glass spheres have an average diameter of about 8 to about 20 micrometers. In at least one embodiment the ratio of the base granule diameter or major surface area to the hollow glass sphere diameter is more than about 4:1. In at least one embodiment the ratio of the base granule diameter or major surface area to the hollow glass sphere diameter is more than about 8:1. In at least one embodiment the hollow glass spheres have a crush strength greater than about 12,000 psi. In at least one embodiment the hollow glass spheres have a crush strength greater than about 14,000 psi. In at least one embodiment the hollow glass spheres have a crush strength greater than about 16,000 psi. In at least one embodiment the roofing granule has a TSR to L* ratio of at least 0.43. In at least one embodiment the roofing granule has a TSR to L* ratio of at least 0.35.

At least one embodiment of the present disclosure provides a roofing granule precursor mixture containing base granules, an aluminum silicate, an alkali metal silicate, and hollow glass spheres. In at least one embodiment the hollow glass spheres comprise about 3 to about 30 by weight of the mixture. In at least one embodiment the hollow glass spheres comprise about 1 to about 50 by weight of the mixture. In at least one embodiment the base granule diameter to the hollow glass sphere diameter is more than about 4:1. In at least one embodiment the ratio of the base granule diameter to the hollow glass sphere diameter is more than about 8:1.

At least one embodiment of the present disclosure provides a method of making roofing granules including providing base granules; applying a coating containing hollow glass spheres, an aluminum silicate, an alkali metal silicate to the base granules; and heating the coated granules to a temperature between about 550° F. and about 1000° F. In at least one embodiment the method further includes applying a second coating to the coated and heated granules and heating the resulting granules to a temperature between about 550° F. and about 1000° F.

At least one embodiment of the present disclosure provides a roofing article having a substrate and a plurality of any embodiment of roofing granules described above.

### BRIEF DESCRIPTION OF THE DRAWINGS

The disclosure may be more completely understood, and those having ordinary skill in the art to which the subject invention relates will more readily understand how to make and use the subject invention, in consideration of the following detailed description of various exemplary embodiments of the disclosure in connection with the accompanying drawings, in which:

FIG. 1 is a depiction of a roofing granule of the present disclosure.

FIG. 2 is a graph comparing the Total Solar Reflectivity and L* (whiteness on the CIE LAB scale) of granules having coatings containing TiO2 and hollow glass spheres.

FIG. 3 is a graph depicting graph comparing the Total Solar Reflectivity and L* (whiteness on the CIE LAB scale) of granules having different ratios of TiO2 and hollow glass spheres in their coatings.

### DETAILED DESCRIPTION

In the following description, reference is made to the accompanying drawings that forms a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

The term “major face area” means the surface area of the largest face or facet of a granule that is sufficiently non-spherical that a diameter cannot be determined or approximated.

The term “base granule” means a granule on which nothing has been coated or applied.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates generally to roofing granules having a layer comprising hollow glass spheres embedded in a ceramic matrix. The described roofing granules can be used to produce roofs with colors darker than, but having at least the same solar reflectivity as, roofing solutions that use TiO2 or other light-colored solar reflective materials. This can allow for roofing materials that are able to meet reflectivity requirements of state or local governments while still providing the aesthetic qualities desired for high slope roofs.

Colored roofing materials using the roofing granules of the present disclosure may provide greater color saturation than traditional building materials. For example, a roof using the roofing granules with one or more colored pigments results in the visible color of the roofing granule to appear closer in color to the colored pigment alone. Without being bound by theory, hollow glass spheres in a layer on the roofing granules is believed to not significantly interfere with the observed color of the colored roofing granule, as compared to roofing granules having only TiO2 or similar light-colored materials such as alumina, calcium carbonate, devitrified glass, white marble, and white cement in a layer on roofing granules. The hollow glass sphere layer may also allow for a broader range of colored roofing granules that could not easily be obtained using traditional solar reflective additive materials.

Granules

The base granules may be any suitable material such as minerals typically used in roofing granules. Examples include igneous rocks, argillite, greenstone, granite, trap rock, silica sand, slate, nepheline syenite, greystone, crushed quartz, slag, and the like.

The structure of the roofing granules can be controlled or selected based upon the application or use in a building construction article. The base granules can be regularly or irregularly shaped. The base granules can also have a variety of shape profiles including, but not limited to, spherical, blocky, plate-like, or disk-like. Granule sizes will be referred to as its diameter or its major face area. The diameter measurement will be used if a granule is generally spherical, such that its approximate size can be understood by referring to its diameter; otherwise the major face area will be used. The base granules and the roofing granules can also be engineered to have a desired shape and blended to provided preferred size and/or shape distributions for optimum packing, coverage, texture, or appearance on bituminous surfaces or for other functions. Suitable granule sizes include about 300 micrometers to about 5 millimeters, about 500 micrometers to about 3 millimeters, and about 1 to about 2 millimeters, although mixtures having larger and smaller sizes may be preferred in some instances.

Ceramic Matrix

The primary components of the ceramic matrix in which the hollow glass spheres are embedded are an alkali metal silicate and an alumina silicate. These precursor materials are mixed and subjected to heat to form the ceramic matrix on the granule.

An exemplary alkali metal silicate coating composition may include an aqueous sodium silicate which may be advantageous due to its relative availability and economy, although similar materials such as potassium silicate may also be substituted wholly or partially therefore. The alkali metal silicate may be designated as M₂O:Si₂, where M represents an alkali metal such as sodium (Na), potassium (K), mixture of sodium and potassium, and the like. The weight ratio of SiO₂ to M₂O can range from about 1.4:1 to about 3.75:1. In some embodiments, weight ratio of SiO₂ to M₂O is about 2.75:1 or about 3.22:1, depending on the color of the granular material to be produced, the former may be more suitable when light colored granules are produced, while the latter may be more suitable when dark colored granules are desired.

The aluminosilicate used can be a clay having the formula Al₂Si₂O₅(OH)₄. A preferred aluminosilicate is kaolin, and its derivatives formed by weathering (kaolinite), moderate heating (dickite), or hypogene processes (nakrite). A Suitable kaolin clay is commercially available as ACTI-MIN® RP-2 from Active Minerals International, LLC, Sparks, Md., USA. Other commercially available and useful aluminosilicate clays for use in the ceramic coating of the granules in the present disclosure are the aluminosilicates known under the trade designations DOVER from Grace Davison of Columbia, Md. and SNO-BRITE from Unimin Corporation of New Canaan, Conn.

Hollow Glass Spheres

The hollow glass spheres embedded in the ceramic matrix provide beneficial solar reflective properties to the roofing granule and the product, such as a shingle, in which the roofing granules are used. The hollow glass spheres are mixed in with the components of the ceramic matrix before firing, so must be able to withstand processing of the ceramic precursor materials, including being subjected to sufficient heat to form the ceramic matrix. Because of this requirement, thermoplastic hollow spheres or glass spheres that will melt during the firing process are not suitable. Although at least some solid glass spheres could withstand the firing process, the inventors found they did not provide the desired solar reflectance properties. Suitable hollow glass spheres include those commercially available as 3M™ Glass Bubbles iM16K from 3M Company, St. Paul, Minn., USA.

The crush strength of hollow glass spheres is measurement that can indicate its ability to withstand processing conditions such as mixing and firing. Crush strength is typically directly proportional to the wall thickness of the hollow microspheres. Preferred crush strengths for hollow glass spheres of the present disclosure are at least about 10,000 psi, at least about 11,000 psi, at least about 12,000 psi, at least about 13,000 psi, at least about 14,000 psi, at least about 15,000 psi, or at least about 16,000 psi. The hollow glass spheres preferably have a softening point greater than the temperature to which the ceramic matrix precursors will be heated.

The hollow glass spheres can be any size suitable to form a coating on the base granule. Examples of suitable sizes include about 5 to about 50 micrometers and about 8 to about 20 micrometers. Examples of suitable ratios of granule diameter or major surface area to the diameter of the hollow glass spheres is at least about 3:1, at least about 4:1, at least about 5:1, at least about 6:1, at least about 7:1, and at least about 8:1.

The hollow glass spheres are preferably substantially clear, rather than translucent or opaque, to enable maximum solar reflectance.

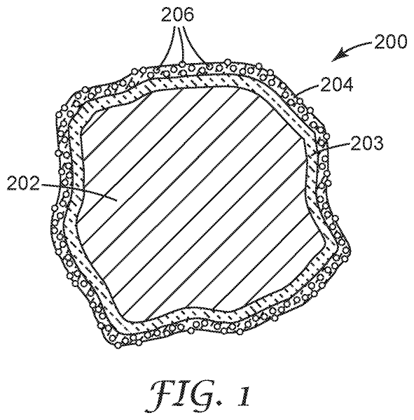

There can be one or more layer(s) of hollow glass spheres embedded in a ceramic matrix on the base granule. These layers may be directly adjacent to the base granule or an outer layer. There may be additional layers of other materials beneath, between, or on a layer of hollow glass spheres embedded in a ceramic matrix. FIG. 1 shows an exemplary roofing granule of the present disclosure. Roofing granule 200 includes a base granule 202 covered by first ceramic layer 203 containing a pigment and no hollow glass spheres and second ceramic layer 204 containing hollow glass spheres 206.

Other Layers

Other layers that may be applied to the granule include ceramic coatings including one or more colored pigments. For example, a granule may be coated with a composition including a colored pigment and an alkali metal silicate binder, which may include lithium silicate, sodium silicate, potassium silicate, and/or combinations thereof. In some exemplary embodiments, an alkoxysilane, such as tetraethoxysilane, and/or a boric acid, borate, or combination thereof, may be added to enhance the durability of the coating, as described by U.S. Patent Application Publication No. 2011/0251051 dated Oct. 13, 2011, and U.S. Patent Application Publication No. 2010/0152030 dated Jun. 17, 2010, respectively, the entirety of each which is incorporated herein by reference.

Method

In some exemplary embodiments, the granules may be coated using an aqueous mixture of pigment, alkali metal silicate, an aluminosilicate, and an optional borate compound. The alkali metal silicate and the aluminosilicate act as an inorganic binder and are a major constituent of the coating. As a major constituent, this material is present at an amount greater than any other component and in some embodiments present at an amount of at least about 25 weight percent of the coating. The coatings from this mixture generally result in a ceramic.

For layers having hollow glass spheres in a ceramic matrix, the hollow glass spheres comprise about 3 to about 30 weight percent, or about 1 to about 50 weight percent, of the mixture.

After applying a coating composition onto the base granules, the coated base granule is heated at elevated temperatures in a rotary kiln, oven, or other suitable apparatus, to temperatures of about 550° F. to about 1000° F. The coating composition may contain ceramic precursor and hollow glass spheres or may contain other components, such as pigment. After the first coating is cured, a second coating may be applied. Like the first coating, it may contain ceramic precursor and hollow glass spheres or may contain other components. The granule is heated a second time to cure the second coating. This process may be repeated to form additional desired layers. At least one layer on the roofing granule comprises a ceramic matrix in which hollow glass spheres are embedded.

Finished Granules and Articles

As previously mentioned, the roofing granules of the present disclosure provide solar reflectance including for roofing products, such as shingles, having darker colors than can be achieved by other solar reflective roofing materials. The ratio of TSR to L* for the roofing granules of the present disclosure are about 0.43 to about 0.52 and about 0.35 to about 0.75.

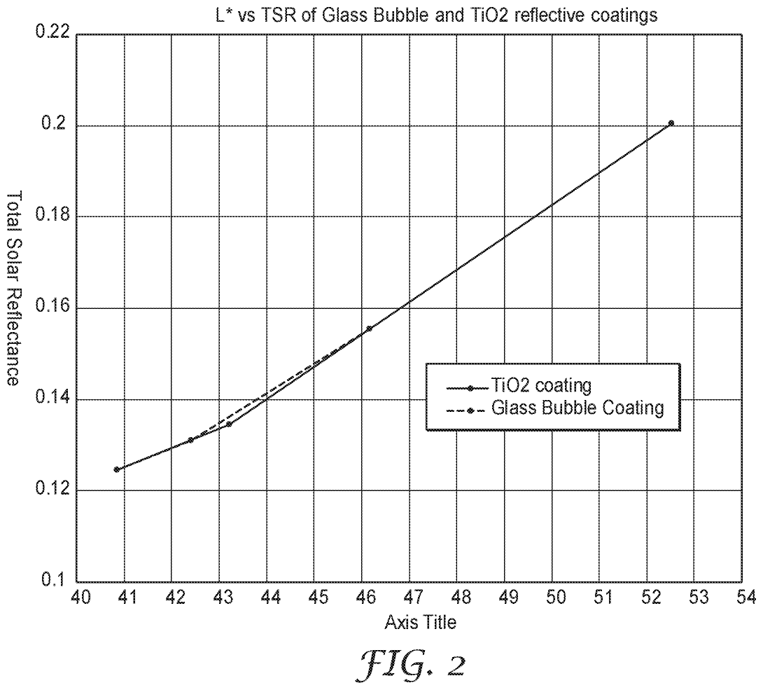

FIG. 2 is a graph comparing the Total Solar Reflectivity and L* (whiteness on the CIE LAB scale) of granules having coatings containing TiO2 and hollow glass spheres.

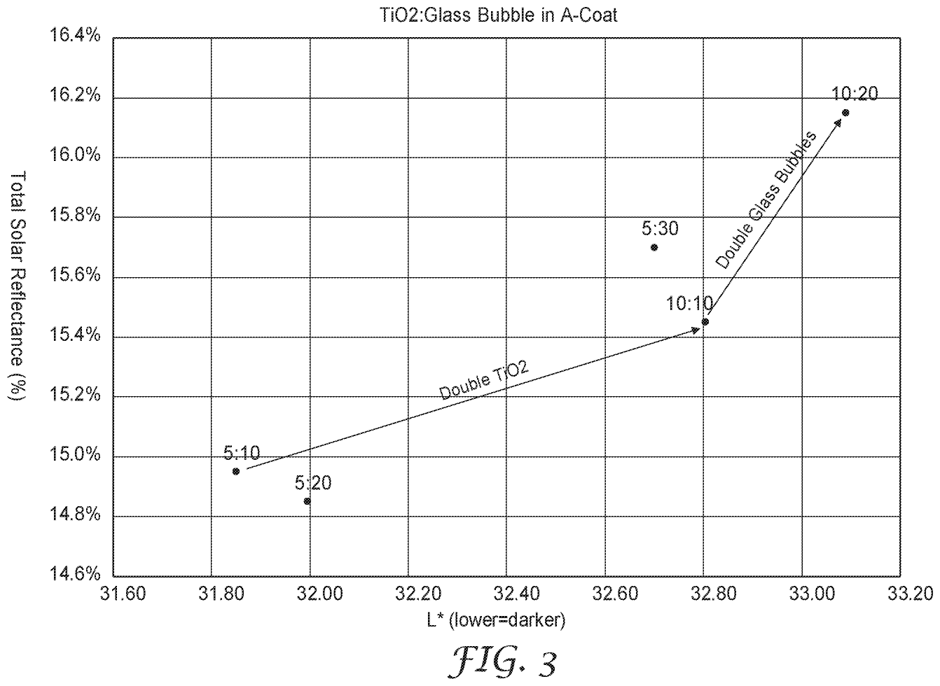

FIG. 3 is a graph depicting graph comparing the Total Solar Reflectivity and L* (whiteness on the CIE LAB scale) of granules having different ratios of TiO2 and hollow glass spheres in their coatings.

Roofing granules of the present disclosure may be incorporated into suitable building products, such as shingles, roll roofing, cap sheets, stone coated tile, as well as other non-roofing surfaces, such as walls, roads, walkways, and concrete.

### EXAMPLES

Materials

The materials with their sources are listed in Table 1. Unless otherwise indicated, all materials were purchased from commercial sources and used as received.

TABLE 1
Materials List

| Trade Designation | Description | Supplier |
|---|---|---|
| ACTI-MIN ® RP-2 | Kaolin clay | Active Minerals |
| | | International, LLC |
| | | Sparks, MD, USA |
| PD | Sodium Silicate | PQ Corporation |
| | | Malvern, PA, USA |
| 10G996 | Chromium oxide black | Shepherd Color |
| | pigment | Company , |
| | | Cincinnati |
| | | OH, USA |
| Krono ® 3025 | Titanium dioxide | Kronos, Inc |
| | | Cranbury, NJ, USA |
| V-12650 | Chromium green pigment | Ferro Corporation |
| | | Mayfield Heights, |
| | | OH, USA |
| 3M ™ GLASS | Hollow spheres made of | 3M Company, |
| BUBBLES | soda-lime-borosilicate | St. Paul, MN, USA |
| iM16K | glass, having a | |
| | softening point | |
| | of about 600° C. | |
| 3M ™ #11 Grade | Roofing Granules | 3M Company, |
| | | Corona, CA, USA |

Experimental Methods

Color

Color was measured using a spectrophotometer with a 0°/45° optical geometry (model LabScan XE Spectrophotometer, commercially available from Hunter Associates Laboratory, Reston, Va., USA). Samples for color measurement were prepared generally following the procedure described in U.S. Pat. No. 4,582,425, “Device for Preparing Colorimeter Sample”. Roofing granules were poured into a layout dish with raised sides and the surface leveled using a metal roller. Results are expressed in terms of lightness value L*.

Total Solar Reflectivity

Total Solar Reflectivity was measured using a reflectometer (model Solar Spectrum Reflectometer (v5), commercially available from Devices and Services Company, Dallas, Tex., USA) using 1.5 air mass setting. Results are expressed as a percent (%) of reflectivity.

Roofing granules were poured into a layout dish with raised sides and the surface was leveled using a metal roller, per the description of the “Device for Preparing Colorimeter Sample” in U.S. Pat. No. 4,582,425.

### Examples 1-2 and Comparative Examples A-C

Roofing granules of Examples 1-2 and Comparative Examples A-C were prepared according to the following description. First coat compositions 1-2 and Comparative Coat Compositions A-C were prepared by mixing the ingredients listed in Table 2, below, at room temperature and using a high shear mixer.

TABLE 2
Ingredients of Comparative Coat Compositions
A-C and First Coat Compositions 1-2

| | Kaolin | Sodium | Deionized | Titanium | Hollow |
|---|---|---|---|---|---|
| | clay | silicate | water | dioxide | spheres |
| | (g) | (g) | (g) | (g) | (g) |
| Comparative Coat | 5 | 22.2 | 9 | 0 | 0 |
| Composition A | | | | | |
| Comparative Coat | 5 | 22.2 | 9 | 1 | 0 |
| Composition B | | | | | |
| Comparative Coat | 5 | 22.2 | 9 | 5 | 0 |
| Composition C | | | | | |
| First Coat | 5 | 22.2 | 9 | 0 | 2.5 |
| Composition 1 | | | | | |
| First Coat | 5 | 22.2 | 9 | 0 | 7.5 |
| Composition 2 | | | | | |

About one kilogram of 11-grade base granules were heated to 200° F. (93° C.) and coated with First Coat Compositions 1-2 and Comparative Coat Compositions A-C using a low shear mixer. Coated granules were removed from the mixing pot and moved into a rotary metal pot, where they were fired from an initial temperature of 300° F. (about 150° C.) until they reached 800° F. (about 275° C.), at which point the roofing granules were removed from the kiln, to produce roofing granules of Examples 1-2 and Comparative Examples A-C.

The roofing granules were allowed to cool to room temperature, and color and total solar reflectivity were measured, following the test methods described above. Results are reported in Table 3, below.

TABLE 3
Properties of roofing granules of Comparative
Examples A-C and Examples 1-2

| | | Total Solar |
|---|---|---|
| | Color | Reflectance |
| | (L*) | (%) |
| Comparative Example A | 40.9 | 12.5 |
| Comparative Example B | 43.2 | 13.5 |
| Comparative Example C | 52.5 | 20.1 |
| Example 1 | 42.4 | 13.1 |
| Example 2 | 46.2 | 15.6 |

### Examples 5-9

Roofing granules of Examples 5-9 were prepared as described above, for Examples 1-4 and Comparative Example A, except that (i) First Coat Compositions 5-9 had the ingredients and amounts shown in Table 4, below; and (ii) a Second Coat Composition was provided.

TABLE 4
Ingredients of First Coat Compositions 5-9

| | | | Deionized | Black | Titanium | Hollow |
|---|---|---|---|---|---|---|
| | Kaolin clay | Sodium silicate | water | pigment | dioxide | spheres |
| | (g) | (g) | (g) | (g) | (g) | (g) |
| First Coat | 11.1 | 22.2 | 7.95 | 1.5 | 5 | 5 |
| Composition 5 | | | | | | |
| First Coat | 11.1 | 22.2 | 7.95 | 1.5 | 2.5 | 5 |
| Composition 6 | | | | | | |
| First Coat | 11.1 | 22.2 | 10 | 1.5 | 5 | 10 |
| Composition 7 | | | | | | |
| First Coat | 11.1 | 22.2 | 11 | 1.5 | 2.5 | 10 |
| Composition 8 | | | | | | |
| First Coat | 11.1 | 22.2 | 15 | 1.5 | 2.5 | 15 |
| Composition 9 | | | | | | |

As previously described, about one kilogram of 11-grade base granules were heated to 200° F. (93° C.) and coated with First Coat Compositions 5-9 using a low shear mixer. Coated granules were removed from the mixing pot and moved into a rotary metal pot, where they were fired from an initial temperature of 300° F. (about 150° C.) until they reached 800° F. (about 275° C.) to produce Coated Granules 5-9. These coated granules were then allowed to cool to 200° F. (93° C.) and coated with a Second Coat Composition, whose formula is shown in Table 5, below.

TABLE 5
Ingredients of Second Coat Composition

| | Kaolin | Sodium | Deionized | Black | Green | Hollow |
|---|---|---|---|---|---|---|
| | clay | silicate | water | pigment | pigment | spheres |
| | (g) | (g) | (g) | (g) | (g) | (g) |
| Second Coat | 5 | 22.50 | 7.95 | 7.50 | 1 | 0.22 |
| Composition | | | | | | |

The coated granules were fired for a second time from an initial temperature of 300° F. (about 150° C.) until they reached 800° F. (about 275° C.) to produce roofing granules of Examples 5-9. After being allowed to cool to room temperature, color and total solar reflectivity of the roofing granules were measured, following the test methods described above. Results are reported in Table 6, below.

TABLE 6
Properties of roofing granules
of Examples 5-9

| | | Total |
|---|---|---|
| | | Solar |
| | Color | Reflectance |
| | (L*) | (%) |
| Example 5 | 32.8 | 15.5 |
| Example 6 | 31.9 | 15.0 |
| Example 7 | 33.1 | 16.2 |
| Example 8 | 32.0 | 14.9 |
| Example 9 | 32.7 | 15.7 |

Those having skill in the art will appreciate that many changes may be made to the details of the above-described embodiments and implementations without departing from the underlying principles thereof. The scope of the present disclosure should, therefore, be determined only by the following claims.

The present invention should not be considered limited to the particular examples described herein, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

1. A roofing granule comprising:
a base granule; and
at least one layer on the base granule comprising hollow glass spheres embedded in a ceramic matrix.

2. The roofing granule of claim 1 wherein the hollow glass spheres are in an outermost layer on the base granule.

3. The roofing granule of claim 1 wherein the hollow glass spheres are in one or more layers beneath an outer layer on the base granule.

4. The roofing granule of claim 3 wherein the outer layer does not comprise hollow glass spheres.

5. The roofing granule of claim 1, wherein the hollow glass spheres have a diameter of about 5 to about 50 micrometers.

6. The roofing granule of claim 1, wherein the hollow glass spheres have an average diameter of about 8 to about 20 micrometers.

7. The roofing granule of claim 1 wherein the ratio of the base granule diameter or major surface area to the hollow glass sphere diameter is more than about 4:1.

8. The roofing granule of claim 1 wherein the ratio of the base granule diameter or major surface area to the hollow glass sphere diameter is more than about 8:1.

9. The roofing granule of claim 1, wherein the hollow glass spheres have a crush strength greater than about 12,000 psi.

10. The roofing granule of claim 1, wherein the hollow glass spheres have a crush strength greater than about 14,000 psi.

11. (canceled)

12. The roofing granule of claim 1 having a TSR to L* ratio of at least 0.43.

13. The roofing granule of claim 1 having a TSR to L* ratio of at least 0.35.

14. A roofing granule precursor mixture comprising:
base granules, an aluminum silicate, an alkali metal silicate, and hollow glass spheres.

15. The roofing granule precursor mixture of claim 14 wherein the hollow glass spheres comprise about 3 to about 30 by weight of the mixture.

16. The roofing granule precursor mixture of claim 14 wherein the hollow glass spheres comprise about 1 to about 50 by weight of the mixture.

17. The roofing granule precursor mixture of claim 14 wherein the ratio of the base granule diameter to the hollow glass sphere diameter is more than about 4:1.

18. The roofing granule precursor mixture of claim 14 wherein the ratio of the base granule diameter to the hollow glass sphere diameter is more than about 8:1.

19. A method of making roofing granules comprising:
providing base granules;
applying a coating containing hollow glass spheres, an aluminum silicate, an alkali metal silicate to the base granules; and
heating the coated granules to a temperature between about 550° F. and about 1000° F.

20. The method of claim 19 further comprising applying a second coating to the coated and heated granules and heating the resulting granules to a temperature between about 550° F. and about 1000° F.

21. A roofing article comprising a substrate and a plurality of roofing granules according to claim 1.
